(19) United States
(12) Patent Application Publication
(10) Pub. No.: US 2013/0194724 A1
(43) Pub. Date: Aug. 1, 2013

(54) ELECTRODE, METHOD FOR FABRICATING THE SAME, AND ELECTROCHEMICAL CAPACITOR INCLUDING THE SAME

(71) Applicant: SAMSUNG ELECTRO-MECHANICS CO., LTD, Suwon (KR)

(72) Inventors: Hak Kwan KIM, Seoul (KR); Jun Hee Bae, Seoul (KR); Ho Jin Yun, Suwon (KR); Bae Kyun Kim, Seongnam (KR)

(73) Assignee: SAMSUNG ELECTRO-MECHANICS CO., LTD, Suwon (KR)

(21) Appl. No.: 13/754,229

(22) Filed: Jan. 30, 2013

(30) Foreign Application Priority Data
Feb. 1, 2012 (KR) 10-2012-0010398

(51) Int. Cl. H01G 11/28

(52) U.S. Cl. CPC H01G 11/28; Y10S 977/948; B82Y 99/00
USPC 361/502; 427/79; 977/948

(57) ABSTRACT

Disclosed herein are an electrode, a method for fabricating the same, and an electrochemical capacitor including the same, the electrode including an electrode current collector; a plurality of first active material layers made of a complex of graphene and carbon nanotubes (CNT) above the electrode current collector; and a plurality of second active material layers made of carbon nanofibers (CNF), each of the second active material layers being interposed between the first active material layers. According to the present invention, an electrochemical device having high capacitance and output can be provided by using materials such as graphene, carbon nanotubes (CNT), and carbon nanofibers (CNF), which have excellent specific surface area and electric conductivity, as an electrode active material, and thereby to fabricate an electrode having a multilayer structure.

### CROSS REFERENCE(S) TO RELATED APPLICATIONS

This application claims the benefit under 35 U.S.C. Section 119 of Korean Patent Application Serial No. 10-2012-0010398, entitled “Electrode, Method for Fabricating the Same, and Electrochemical Capacitor Including the Same” filed on Feb. 1, 2012, which is hereby incorporated by reference in its entirety into this application.

### BACKGROUND OF THE INVENTION

1. Technical Field

The present invention relates to an electrode, a method for fabricating the same, and an electrochemical capacitor including the same.

2. Description of the Related Art

A supercapacitor, which has very large storage capacitance, is called an ultracapacitor or an ultrahigh-capacitance capacitor. As a technical term, the super capacitor is called an electrochemical capacitor in order to be discernible from an existing electrostatic or electrolytic capacitor.

The supercapacitors may be divided into an electronic double layer capacitor storing electricity through electrostatic absorption and desorption of ions, a pseudocapacitor storing electricity through oxidation-reduction reaction, and a hybrid capacitor having an asymmetric electrode form.

A battery, which is the most general energy storage device, may store significantly large energy, with a relatively small volume and weight, and generate an appropriate output in various purposes and thereby to be used for various purposes. However, the battery has low storage characteristics and cycle lifespan regardless of the kinds thereof. This results from natural deterioration of chemical materials or deterioration due to the use of chemical materials contained in the battery. Since there are no particular alternatives to the battery, the battery is unavoidably used despite these disadvantages.

While, the supercapacitor employs a charging phenomenon, which is caused by simple movement of ions to an interface between an electrode and an electrolyte or a surface chemical reaction, unlike the battery employing a chemical reaction. Accordingly, the supercapacitor has been spotlighted as a next generation storage device, which is usable as an auxiliary battery or a product substituting for the battery due to rapid charging and discharging, high charging and discharging efficiency, and semi-permanent cycle lifespan.

However, in spite of these advantages, the supercapacitor has lower capacitance than the battery, and thus, has many restrictions in view of usability. Therefore, currently, it is the most important problem of the supercapacitor to maintain high output characteristics and improve capacitance of cells.

This supercapacitor is operated by an electrochemical mechanism where a voltage of several volts is applied to both ends of an electrode of a unit cell so that ions in an electrolytic liquid move along an electric field to be adsorbed onto a surface of the electrode. The supercapacitor basically consists of porous electrodes, an electrolyte, current collectors, and a separator.

The porous electrode may be fabricated through preparing electrode particles such as an active material, a conducting agent, a binder, a solvent, other additives, and the like, preparing a paste (slurry) by mixing them, and producing an electrode by coating the paste on a current collector such as metal foil, as shown in FIG. 1. Active carbon is mainly used as the active material of the electrode, and porosity is conferred on a surface of the electrode. Since specific capacitance thereof is proportional to a specific surface area, energy density can be increased due to high capacitance of electrode materials.

This electrode of the supercapacitor may be fabricated by coating an electrode active material paste 10 on a surface of a current collector 20 in a flat type to form an active material layer. However, an electrode active material, a conducting agent, and the like, contained in the electrode active material paste, have different particle sizes from one another, and thus, uniform dispersion thereof is not easily achieved. Further, application thereof is difficult in the case where high output is requested since reduction in contact resistance at an interface is slight, and thus, in fact, reduction in resistance is not large.

In order to solve this disadvantage, the electrode may be fabricated by forming a conductive layer on an electrode current collector in advance, and then coating an active material layer on the conductive layer. However, this method also has limitations in reduction in resistance due to the use of a single active material such as activated carbon in the coating layer.

### RELATED ART DOCUMENTS

### Patent Document

(Patent Document 1) U.S. Pat. No. 7,943,238B

### SUMMARY OF THE INVENTION

An object of the present invention is to provide an electrode, capable of complementing capacitance characteristics of an electrode of a supercapacitor using the existing activated carbon as an active material, and compensating for faults generated at the time of fabrication by including a multilayer-structured active material layer using raw materials having excellent physical and chemical properties, and thus being applicable to actual products, and a method for fabricating the same and an electrochemical capacitor including the same.

According to one exemplary embodiment of the present invention, there is provided an electrode including: an electrode current collector; a plurality of first active material layers made of a complex of graphene and carbon nanotubes (CNT) above the electrode current collector; and a plurality of second active material layers made of carbon nanofibers (CNF), each of the second active material layers being interposed between the first active material layers.

The first active material layer may have a thickness of 1˜5 μm.

The second active material layer formed between the first active material layers may serve as a binding layer for binding the first active material thereabove and therebelow, which are contacted with the second active material layer.

The graphene constituting the first active material layer may have a specific surface area of 1,800˜2,500 m²/g and electric conductivity of 10³˜10⁵ S/cm.

The carbon nanotubes (CNT) constituting the first active material layer may have a specific surface area of 800˜1,500 m²/g and electric conductivity of 10²˜10³ S/cm.

The electrode may have a multilayer structure where one first active material layer, one second active material layer, and another first active material layer are sequentially laminated on the electrode current collector.

According to another exemplary embodiment of the present invention, there is provided a method for fabricating an electrode, the method including: a first step of coating one first active material layer made of a complex of graphene and carbon nanotubes (CNT) on an electrode current collector; a second step of coating one second active material layer made of carbon nanofibers (CNF) on the first active material layer; and a third step of coating another first active material layer made of a complex of graphene and carbon nanotubes (CNT) on the second active material layer.

The second step and the third step may be repeatedly performed to provide an electrode having a multilayer structure.

In the complex of graphene and carbon nanotubes (CNT), the graphene may act as an active material and a surfactant and the carbon nanotubes may act as a conducting agent, a spacer, and a binder.

According to still another exemplary embodiment of the present invention, there is provided an electrochemical capacitor including the electrode.

The electrode may be used as at least one selected from a cathode and an anode.

### BRIEF DESCRIPTION OF THE DRAWINGS

FIG. 1 shows a procedure for fabricating an electrode of a general supercapacitor;

FIG. 2 shows a structure of the electrode of the general supercapacitor; and

FIG. 3 shows a structure of a new electrode of a supercapacitor according to an exemplary embodiment of the present invention.

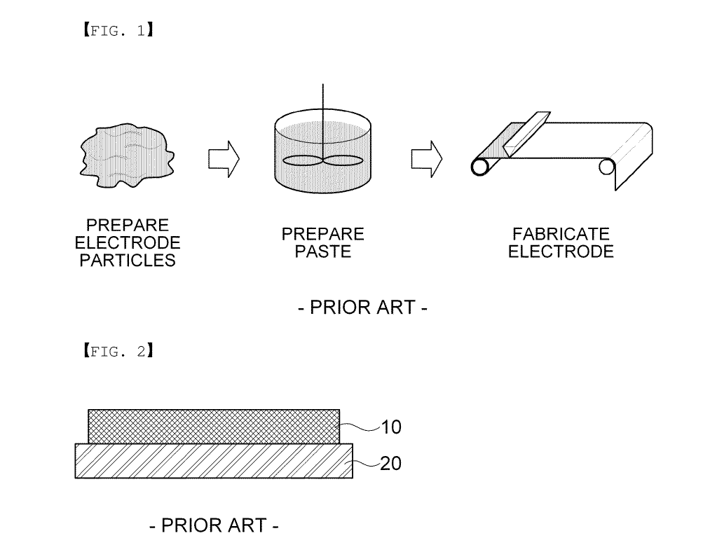

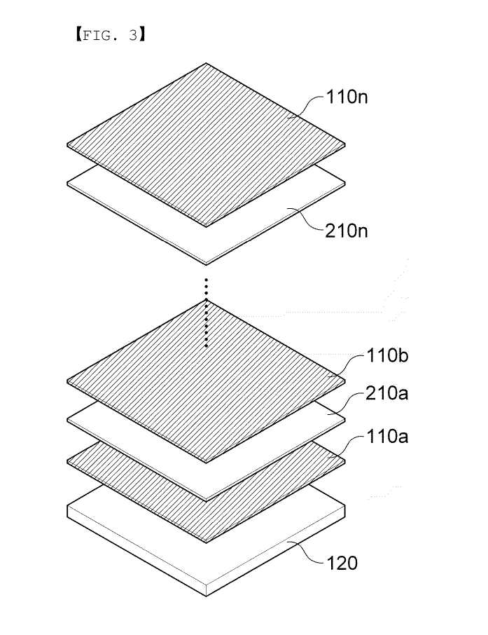

### DESCRIPTION OF THE PREFERRED EMBODIMENTS

Hereinafter, the present invention will be described in more detail with reference to the accompanying drawings.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention provides an electrode having a new structure by using a carbon material such as graphene, carbon nanotubes, or carbon nanofibers, that is capable of increasing capacitance of an electrochemical capacitor and having excellent properties, but is problematic in a process, instead of including a single active material layer using a carbon material such as activated carbon, like an electrode of the existing electrochemical capacitor, and a method for fabricating the same and an electrochemical capacitor including the same.

The electrode according to an exemplary embodiment of the present invention include an electrode current collector, a plurality of first active material layers made of a complex of graphene and carbon nanotubes (CNT), and second active material layers between the plurality of first active material layers consisting of carbon nanofibers (CNF). A plurality of layers are appropriately applied depending on the uses or design factors, thereby finally fabricating an electrode having desired thickness, capacitance, and resistance.

Specifically, as shown in FIG. 3, one first active material layer 110a made of a complex of graphene and carbon nanotubes (CNT) is formed on an electrode current collector 120, and then, one second active material layer 210a made of carbon nano fiber (CNF) is formed on the first active material layer 110a. Then, another first active material layer 110b made of a complex of graphene and carbon nanotubes (CNT) is formed on the second active material layer 210a. That is, in order to enhance adhesion strength between the first active material layers 110a and 110b made of a complex of graphene and carbon nanotubes (CNT), the second active material layer 210a made of carbon nanotubes (CNF) is formed between the first active material layers 110a and 110b.

In the case of the existing electrode including a single active material layer using activated carbon, many of the micropores provided in activated carbon itself are not sufficiently utilized. That is, since there are many portions to which an electrolytic liquid is inaccessible even though an actual specific surface area of the activated carbon is above 2000 m²/g, the specific surface area of a portion that is utilized is not even half thereof, and thus, a large capacitance loss is incurred. In addition, the activated carbon has limitations in output characteristics due to low electric conductivity thereof.

In the present invention, therefore, high capacitance and output can be realized by using graphene and carbon nanotubes (CNT) having a larger specific surface area and higher electric conductivity than the activated carbon as an active material of the electrochemical capacitor.

Specifically, it is preferable to use a material having a specific surface area of 1,800˜2,500 m²/g and electric conductivity of 10³˜10⁵ S/cm for the graphene constituting the first active material layer in order to realize high capacitance and improve output characteristics.

In addition, the graphene is advantageous in view of capacitance and output characteristics since the larger an effective specific surface area thereof, with which an electrolyte is contacted, the smaller a powder size thereof. However, in the case where the power size thereof is too small, the possibilities of unfavorable dispersion and agglomeration may increase. Therefore, an appropriate powder size of the graphene is about 50˜300 nm.

Further, in order to realize high capacitance and improve output characteristics, it is preferable to use a material having a specific surface area of 800˜1,500 m²/g and electric conductivity of 10²˜10³ S/cm, for the carbon nanotubes (CNT) which are contained together with the graphene, as the complex, in the first active material layer. The carbon nanotube appropriately has a size of about 20˜200 nm in order to maintain uniform dispersibility with the graphene and strength of the electrode. The reason why the graphene and the carbon nanotubes are not used as electrode materials for current products in spite of a high specific surface area and high electric conductivity thereof is that the graphene has restacking problems and the carbon nanotubes have limitations in dispersion and stacking density thereof.

However, in the present invention in which the graphene and the carbon nanotubes are mixed and used, the graphene acts as an active material and a surfactant and the carbon nanotubes act as a conducting agent, a spacer, and a binder, in the complex of graphene and carbon nanotubes.

Therefore, the graphene and the carbon nanotube are mixed, and then a method such as sonication or the like is applied thereto, thereby forming a complex layer of graphene and carbon nanotubes (CNT) which are uniformly distributed.

Therefore, each of the second active material layers formed between the first active material layers acts as a binding layer that binds the respective first active material layers thereabove and therebelow, which are contacted with the second active material layer, thereby enhancing binding strength.

Meanwhile, in reality, there have been many experimental attempts on the complex using the graphene and the carbon nanotubes (CNT), and local characteristics thereof have been confirmed to be excellent, but application thereof to products was impossible. The reason is that viscosity thereof needs to be very low in order to form a layer where the graphene and the carbon nanotubes are uniformly dispersed. One layer thereof has a very thin thickness of 1 μm or smaller due to too low viscosity thereof, resulting in low binding strength, and thus, the complex of using graphene and carbon nanotubes (CNT) has limitations when being applied to products.

However, the respective first active material layers 110a and 110b made of the complex of graphene and carbon nanotubes (CNT) of the present invention, which are formed by applying the above method, have a thickness of 1˜5 μm, and thus, can be applied to actual products. However, as set forth in the present method, the second active material layer made of carbon nanofibers is used as a binding layer, and a plurality of the first active material layers are laminated while each of the first active material layers is disposed between the second active material layers, so that a laminate having a thickness of about 100 μm can be sufficiently manufactured.

The laminate may have a multilayer structure where one first active material layer, one second active material layer, and another first active material layer are sequentially formed on the electrode current collector, and again second active material layers and first active material layers are alternately formed and sequentially laminated thereon.

In addition, a high specific surface area of the carbon nanofibers and a 3-D network structure among entangled fibers allow mechanical interlocking between the respective first active material layers made of a complex of graphene and carbon nanotubes (CNT), so that improvement in binding strength can be expected, and thus, application to actual products can be realized.

The first active material layers 110a and 110b made of the complex of graphene and carbon nanotubes (CNT) according to the present invention may have a thickness in the range of 1˜5 μm. If the thickness thereof is below 1 μm, this thickness may be advantageous in resistance characteristics. However, it has limitations in that the active material layers are applied to actual products, since the number of times of lamination is very large in order to implement capacitance of several tens to several thousands of F as an energy storage device, and furthermore, application thereof is actually impossible due to high process costs. If the thickness thereof is above 5 μm, this thickness may be advantageous in view of a process, but does not exhibit remarkable characteristic improvement in capacitance and resistance as compared with the existing active material electrode.

In addition, preferably, the second active material layer formed between the first active material layers and made of carbon nanofibers has a thickness in the range of 0.5˜1 μm. If the thickness thereof is below 0.5 μm, binding strength thereof for mechanically binding the first active material layers may be reduced. If the thickness thereof is above 1 μm, a portion of the overall electrode that is occupied by the second active material layer is increased, and a loss is made in overall capacitance.

The carbon nanotubes constituting the second active material layer according to the present invention, preferably, have excellent mechanical properties, such as, a length of 10˜30 μm, a specific surface area of ˜20 m²/g, and a diameter of 80˜150 nm.

Meanwhile, the electrode according to the present invention may be fabricated through a first step of coating one first active material layer made of a complex of graphene and carbon nanotubes (CNT) on an electrode current collector, a second step of coating one second active material layer made of carbon nanofibers (CNF) on the first active material layer, and a third step of coating another first active material layer made of a complex of graphene and carbon nanotubes (CNT) on the second active material layer.

In the first step, one first active material layer is formed on the electrode current collector in a complex form where the graphene and the carbon nanotubes (CNT) are mixed and dispersed. In the complex of graphene and carbon nanotubes, the graphene may act as an active material and a surfactant and the carbon nanotubes may act as a conducting agent, a spacer, and a binder. Therefore, a solvent, a conducting agent, a binder, and the like, included in the electrode using activated carbon as an active material do not need to be separately added. However, a solvent, a conducting agent, a binder, and the like used in the existing activated carbon based electrode may be included, as necessary, but kinds thereof are not particularly limited.

In the second step, one second active material layer made of carbon nanofibers (CNF) is coated on the first active material layer. Here, in the case where CNF is made into a paste type and this paste is coated on the first active material layer, a coma roll coating manner and a spin coating manner may be all employed, and like the existing electrode fabricating method, a solvent, a binder, and the like may be added to the CNF to prepare a slurry, and this slurry may be coated on the first active material layer. Here, a non-water based solvent such as NMP or IPA, or a water-based solvent may be used, but the solvent is not particularly limited.

Then, again, another first active material layer is coated on the second active material layer in a complex form where graphene and carbon nanotubes (CNT) are mixed and dispersed.

Therefore, the second active material layer made of carbon nanofibers (CNF) acts as a binding layer between the first active material layers made of graphene and carbon nanotubes (CNT), and thus, serves to enhance binding strength between the first active material layers.

Further, in the electrode fabricated according to the uses thereof, the second step and the third step are repeatedly performed so that the electrode can have a multilayer structure.

In addition, the present invention can provide a supercapacitor including the electrode fabricated according to the above procedure.

The electrode according to the present invention may be used as both or either of a cathode and an anode in the supercapacitor.

A cathode and an anode are prepared by using the electrode, insulated from each other by a separator, impregnated with an electrolytic liquid, and then inserted in a case, thereby manufacturing the supercapacitor according to the present invention.

In the case where the electrode having a structure represented in the present invention is applied to a supercapacitor, in particular, an electric double layer capacitor (EDLC) cell, this capacitor has higher energy density and power density as compared with an EDLC cell based on the existing activated carbon based electrode, and thus, it is partially applicable to an actual secondary battery.

Any material used in the electric double layer capacitors or lithium ion batteries in the related art may be used for a current collector used in the cathode according to the present invention. Examples of the material may be at least one selected from the group consisting of aluminum, stainless, titanium, tantalum, and niobium, and among them, aluminum is preferable.

Preferably, the cathode current collector may have a thickness of about 10 to 30 μm. An example of the current collector may include a metal foil, an etched metal foil, or those having holes penetrating through front and rear surfaces thereof, such as an expanded metal, a punching metal, a net, foam, or the like.

In addition, any material used in the electric double-layer capacitors or lithium ion batteries in the related art may be used for a current collector used in the anode according to the present invention. Examples of the material may be stainless, copper, nickel, or an alloy thereof, and among them, copper is preferable. Also, the anode current collector preferably has a thickness of about 10˜30 μm. Examples of the above current collector may include a metal foil, an etched metal foil, or those having holes penetrating through front and rear surfaces thereof, such as an expanded metal, a punching metal, a net, foam, or the like.

For the separator according to the present invention, any material that can be used in the electric double layer capacitors or lithium ion batteries of the related art may be used. A microporous film prepared from at least one polymer selected from the group consisting of polyethylene (PE), polypropylene (PP), polyvinylidene fluoride (PVDF), polyvinylidene chloride, polyacrylonitrile (PAN), polyacrylamide (PAAm), polytetrafluoroethylene (PTFE), poly-sulfone, polyethersulfone (PES), polycarbonate (PC), polyamide (PA), polyimide (PI), polyethylene oxide (PEO), polypropylene oxide (PPO), cellulose-based polymers, and polyacryl-based polymers may be used as the separator. In addition, a multilayer film in which the porous films are laminated may be used, and among them, cellulose-based polymers may be preferably used.

The separator, preferably, has a thickness of about 10 to 40 μm, but is not limited thereto.

As the electrolytic liquid of the present invention, an organic electrolytic liquid containing non-lithium salt, such spyro-based salt, TEABF4, TEMABF4 or the like, or containing lithium salt, such as, LiPF₆, LiBF₄, LiCLO₄, LiN(CF₃SO₂)₂CF₃SO₃Li, LiC(SO₂CF₃)₃, LiAsF₆, or LiSbF₆, or a mixture thereof may be used. Examples of the solvent may include at least one selected from the group consisting of acrylonitrile-based solvents, ethylene carbonate, propylene carbonate, dimethyl carbonate, ethylmethyl carbonate, sulfolane, and dimethoxyethane, but are not limited thereto. An electrolytic liquid obtained by combination of solutes and the solvents has high withstand voltage and high electric conductivity. A concentration of electrolyte in the electrolytic liquid is preferably 0.1 to 2.5 mol/L, and more preferably 0.5 to 2 mol/L.

As a case (exterior material) of the electrochemical capacitor of the present invention, a laminate film containing aluminum conventionally used in secondary batteries and electric double layer capacitors may be used, but the case of the present invention is not particularly limited thereto.

Hereinafter, examples of the present invention will be described in detail. The following examples merely illustrate the present invention, but the scope of the present invention should not be construed to be limited by these examples. Further, the following examples are illustrated by using specific compounds, but it is apparent to those skilled in the art that equivalents thereof are used to obtain equal or similar levels of effects.

### Example 1

### Fabrication of Electrode

A first electrode active material slurry was prepared by mixing, firstly, 30 g of graphene (specific surface area: 2300 m²/g, electric conductivity: 10⁴S/cm) and 30 g of CNT (specific surface area: 1200 m²/g, electric conductivity: 10³S/cm) and then 2.5 g of CMC and 1.0 g of PVP, in 150 g of water, followed by stirring.

The first electrode active material slurry was coated on a 20 μm-thickness aluminum etching foil by a spin coater, followed by temporary drying, thereby forming a first electrode active material layer having a thickness of 5 μm.

A second electrode active material paste using carbon nanofibers (that is, a slurry prepared by mixing 30 g of CNF (length: 20 μm, specific surface area: ˜18 m²/g, diameter: 100 nm), 2.5 g of CMC, and 1.0 g of PVP in 150 g of water) was coated on the first electrode active material layer, thereby forming a second electrode active material layer having a thickness of 1 μm.

The first electrode active material slurry and the second electrode active material slurry were repeatedly coated, so that the electrode had an overall cross-sectional thickness of 60 μm, and the thus obtained electrode was dried under the vacuum condition at 120° C. for 48 hours, before cell assembling.

### Comparative Example 1

### Fabrication of Electrode

An electrode active material slurry was prepared by mixing 85 g of general activated carbon (specific surface area: 2150 m²/g, electric conductivity: 10⁻¹ S/cm), 12 g of acetylene black as a conducting agent, and 3.5 g of CMC, 12.0 g of SBR, and 5.5 g of PTFE, as a binder, in 225 g of water, followed by stirring.

The electrode active material slurry was coated on a 20 μm-thickness aluminum etching foil by using a comma coater, followed by temporary drying, and then the resulting structure was cut into 50 mm×100 mm electrodes. The electrode had a cross-sectional thickness of 60 μM. The electrode was dried under the vacuum condition at 120° C. for 48 hours, before cell assembling.

### Example 2

### Manufacture of Electrochemical Capacitor

A separator (TF4035 from NKK, cellulose-based separator) was interposed between a cathode and an anode, which were fabricated in the example 1, and then the resulting structure was impregnated with an electrolytic liquid (within a acrylonitrile-based solvent, TEABF4 salt concentration: 1.5 mol/L), which was then put and sealed in a laminated film case.

### Comparative Example 2

### Manufacture of Electrochemical Capacitor

A separator (TF4035 from NKK, cellulose-based separator) was interposed between a cathode and an anode, which were fabricated in the comparative example 1, and then the resulting structure was impregnated with an electrolytic liquid (within a acrylonitrile-based solvent, TEABF4 salt concentration: 1.5 mol/L), which was then put and sealed in a laminated film case.

### Experimental Example

### Evaluation on Capacitance of Electrochemical Capacitor Cell

In the constant temperature condition of 25° C., each of the thus obtained cells was charged to 2.5V at current density of 1 mA/cm² by constant-current and constant-voltage, which is then kept for 30 minutes, and then discharged at a constant current rate of 1 mA/cm². This charging and discharging was repeated three times, and then capacitance thereof at the last cycle was measured. The results were tabulated in Table 1. In addition, a resistance characteristic of each cell was measured by an ampere-ohm meter and impedance spectroscopy, and the results were tabulated in Table 1.

TABLE 1

| | Initial capacitance | Resistance |
|---|---|---|
| | (F) | (AC ESR, mΩ) |
| Comparative | 10.33 | 18.74 |
| Example 2 | | |
| Example 2 | 19.88 | 9.41 |

As shown in Table 1, it can be confirmed that, in the example 2, specific surface areas and low-resistance properties of two kinds of active materials constituting the electrode were sufficiently reflected in cell characteristics, and thus, a decrease in capacitance and an increase in resistance due to the dead pore volume of the existing activated carbon based electrode (comparative example 2) were reduced.

According to the exemplary embodiments of the present invention, the electrode having a multilayer structure is fabricated by using materials such as graphene, carbon nanotubes (CNT), and carbon nanofibers (CNF), which have excellent specific surface area and electric conductivity, as an electrode active material, and thus, electrochemical devices having high capacitance and output can be provided.

Although the present invention has been shown and described with the exemplary embodiment as described above, the present invention is not limited to the exemplary embodiment as described above, but may be variously changed and modified by those skilled in the art to which the present invention pertains without departing from the scope of the present invention.

1. An electrode comprising:
an electrode current collector;
a plurality of first active material layers made of a complex of graphene and carbon nanotubes (CNT) above the electrode current collector; and
a plurality of second active material layers made of carbon nanofibers (CNF), each of the second active material layers being interposed between the first active material layers.

2. The electrode according to claim 1, wherein the first active material layer has a thickness of 1˜5 μm.

3. The electrode according to claim 1, wherein the second active material layer formed between the first active material layers serves as a binding layer for binding the first active material thereabove and therebelow, which are contacted with the second active material layer.

4. The electrode according to claim 1, wherein the graphene constituting the first active material layer has a specific surface area of 1,800˜2,500 m²/g and electric conductivity of 103˜105 S/cm.

5. The electrode according to claim 1, wherein the carbon nanotubes (CNT) constituting the first active material layer have a specific surface area of 800˜1,500 m²/g and electric conductivity of 102˜103 S/cm.

6. The electrode according to claim 1, wherein the electrode has a multilayer structure where one first active material layer, one second active material layer, and another first active material layer are sequentially laminated on the electrode current collector.

7. A method for fabricating an electrode, the method comprising:
coating one first active material layer made of a complex of graphene and carbon nanotubes (CNT) on an electrode current collector;
coating one second active material layer made of carbon nanofibers (CNF) on the first active material layer; and
coating another first active material layer made of a complex of graphene and carbon nanotubes (CNT) on the second active material layer.

8. The method according to claim 7, wherein the coating one second active material layer and the coating another first active material layer are repeatedly performed to provide an electrode having a multilayer structure.

9. The method according to claim 7, wherein in the complex of graphene and carbon nanotubes (CNT), the graphene acts as an active material and a surfactant and the carbon nanotubes act as a conducting agent, a spacer, and a binder.

10. An electrochemical capacitor comprising the electrode according to claim 1.

11. The electrochemical capacitor according to claim 10, wherein the electrode is used as at least one selected from a cathode and an anode.
